(19) United States
(12) Patent Application Publication
(10) Pub. No.: US 2005/0051984 A1
(43) Pub. Date: Mar. 10, 2005

(54) Skateboard truck

(76) Inventor: Alfred Williams, San Francisco, CA (US)

Correspondence Address: JACK LO, 617 VIEWRIDGE DRIVE, PACIFICA, CA, 94044, US

(21) Appl. No.: 10/858,003

(22) Filed: Jun. 1, 2004

Related U.S. Application Data
(63) Continuation-in-part of application No. 10/658,244, filed on Sep. 9, 2003.

(51) Int. Cl. B62M 1/00

(52) U.S. Cl. 280/87.042

(57) ABSTRACT

A skateboard truck insert is positioned between an axle and a base plate of a skateboard truck to reduce turning radius but still maintain directional stability. The insert is comprised of an intermediary member with a pin on top for mating with a pin receiving hole in the base plate. The intermediary member includes a mounting portion with a through hole. First and second bushings are positioned on either side of the mounting portion. First and second washers are positioned against respective outer ends of the bushings. A bolt is positioned through the washers, bushings, and the hole for mating with the bolt receiving hole on the base plate of the truck. A pin receiving hole and a bolt receiving hole are positioned on a bottom of the intermediary member for respectively receiving a pin and a bolt extending from the axle of the truck.

### CROSS REFERENCE TO RELATED APPLICATIONS

I claim the priority of patent application Ser. No. 10/658,244 filed on Sep. 9, 2003, now abandoned.

### BACKGROUND OF THE INVENTION

1. Field of the Invention

The invention broadly relates to skateboards.

2. Prior Art

A skateboard is comprised of an elongated board with a pair of trucks attached underneath. Each truck is comprised of a base plate attached to the board, an axle attached to the base plate with a bolt, and wheels attached to the axle. The axle has an upwardly projecting pin which is positioned inside a pin receiving hole in the base plate. The bolt is positioned through an oversized hole in a mounting portion of the axle. The bolt is centered within the hole by resilient bushings on either side of the mounting portion. The bolt and the pin form a divergent angle in the direction towards the board. When the board is rolled about a longitudinal axis to either side by foot pressure, the axle is pivoted about the pin to steer the wheels in a corresponding direction. The trucks are mounted as mirror images of each other, so that they simultaneously steer in opposite directions in response to board roll.

The resilient bushings provide compliance to enable the bolt to move laterally within the hole in the mounting portion, and provide increasing roll resistance with increasing roll angle of the board. Roll resistance is determined by the hardness of the bushings, and the clamping force applied on the bushings by the bolt, which is adjustable for tuning roll resistance. The bushings must provide enough resistance to prevent the wheels from steering too easily, that is, to provide suitable directional stability. Higher resistance provides good directional stability but limits turning radius, whereas lower resistance enables a tight turning radius but sacrifices some directional stability.

### BRIEF SUMMARY OF THE INVENTION

A skateboard truck insert is positioned between an axle and a base plate of a skateboard truck to reduce turning radius but still maintain directional stability. The insert is comprised of an intermediary member with a pin on top for mating with a pin receiving hole in the base plate. The intermediary member includes a mounting portion with a through hole. First and second bushings are positioned on either side of the mounting portion. First and second washers are positioned against respective outer ends of the bushings. A bolt is positioned through the washers, bushings, and the hole for mating with the bolt receiving hole on the base plate of the truck. A pin receiving hole and a bolt receiving hole are positioned on a bottom of the intermediary member for respectively receiving a pin and a bolt extending from the axle of the truck.

### BRIEF DESCRIPTION OF THE SEVERAL VIEWS OF THE DRAWING

FIG. 1 is an exploded view of the present skateboard truck insert.

FIG. 2 is a side perspective view of the skateboard truck insert installed on a truck of a skateboard, wherein the truck is in a neutral steering position.

FIG. 3 is a bottom view of the truck insert and skateboard of FIG. 2.

FIG. 4 is a side perspective view of the skateboard truck on the skateboard, wherein the truck is in a turned position.

FIG. 5 is a bottom view of the truck insert and skateboard of FIG. 4.

FIG. 6 is a side perspective of an alternative embodiment thereof.

### DRAWING REFERENCE NUMERALS

| | |
|---|---|
| 10. | Truck Insert |
| 11. | Intermediary Member |
| 12. | Truck Insert Pin |
| 13. | Top |
| 14. | Mounting Portion |
| 15. | Through Hole |
| 16. | First Recess |
| 17. | Second Recess |
| 18. | Bushing |
| 19. | Bushing |
| 20. | First Washer |
| 21. | Second Washer |
| 22. | Truck Insert Bolt |
| 23. | Axle Pin Receiving Hole |
| 24. | Axle Bolt Receiving Hole |
| 25. | Bottom |
| 26. | Skateboard |
| 27. | Axle |
| 28. | Base Plate |
| 29. | Axle Bolt |
| 30. | Bolt Receiving Hole |
| 31. | Pin Receiving Hole |
| 32. | Axle Pin |
| 33. | Bushing |
| 34. | Bushing |
| 35. | Mounting Portion |
| 36. | Washer |
| 37. | Washer |
| 38. | Wheel |
| 39. | Wheel |
| 40. | Board |
| 41. | Arrow |
| 42. | Arrow |
| 43. | Arrow |
| 44. | Truck Insert |
| 45. | Skateboard |
| 46. | Axle |
| 47. | Base Plate |
| 48. | Intermediary Member |
| 49. | Pin Receiving Hole |
| 50. | Bolt Receiving Hole |
| 51. | Truck Insert Bolt |
| 52. | Mounting Portion |
| 53. | Truck Insert Pin |
| 54. | Bushing |
| 55. | Bushing |
| 56. | Washer |
| 57. | Washer |
| 58. | Axle Pin |
| 59. | Axle bolt |

### DETAILED DESCRIPTION OF THE INVENTION

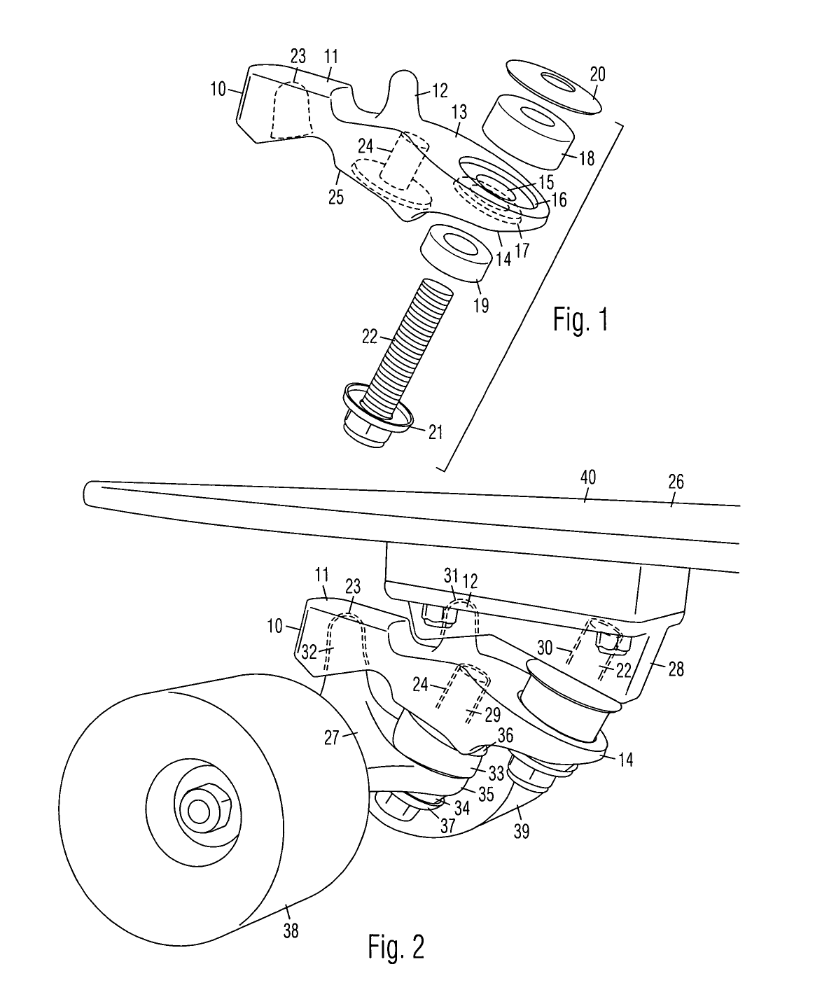

FIG. 1

A skateboard truck insert 10 shown in FIG. 1 is arranged for being positioned between an axle and a base plate of a skateboard truck for reducing turn radius but still maintaining directional stability. Truck insert 10 is comprised of an intermediary member 11 with a truck insert pin 12 on a top 13 for mating with a pin receiving hole in the base plate. Intermediary member 11 includes a mounting portion 14 with a through hole 15, and recesses 16 and 17 on either side of mounting portion 14 coaxial with through hole 15. Resilient first and second bushings 18 and 19 are for being positioned in a first recess 16 and a second recess 17 on either side of mounting portion 14. First cupped washer 20 and second cupped washer 21 are for being positioned against respective outer ends of bushings 18 and 19. A truck insert bolt 22 is for being positioned through washers 20 and 21, bushings 18 and 19, and through hole 15 for mating with the bolt receiving hole on the base plate of the truck. An axle pin receiving hole 23 and a threaded axle bolt receiving hole 24 are positioned on a bottom 25 of intermediary member 11 for respectively receiving an axle pin and an axle bolt extending from the top of axle of the truck. Truck insert pin 12 and truck insert bolt 22 on top of intermediary member 11 are longitudinally offset from pin receiving hole 23 and bolt receiving hole 24 on the bottom of intermediary member 11.

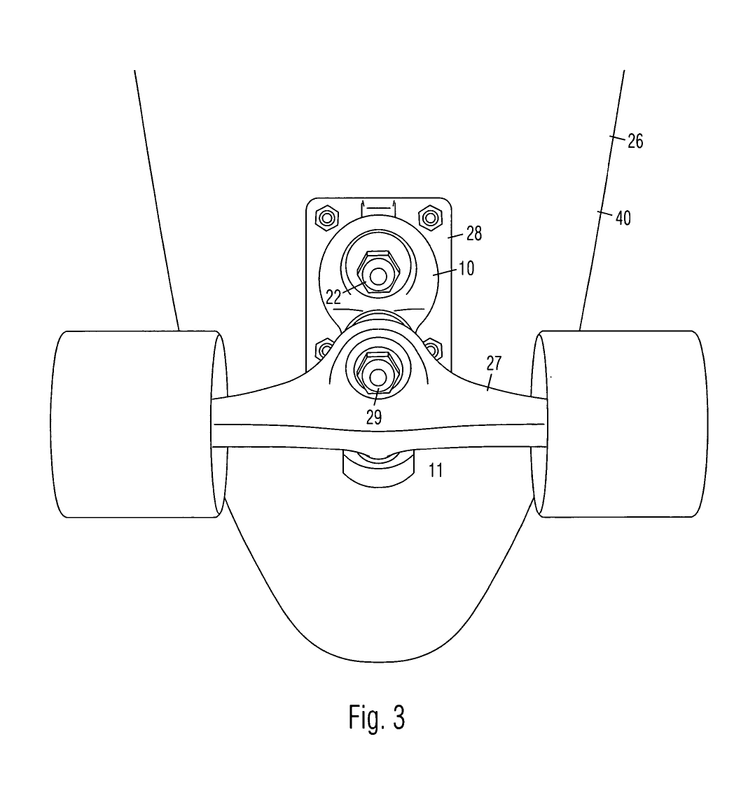

FIGS. 2-3

Truck insert 10 is shown in FIG. 2 installed on a skateboard 26. An axle 27 of skateboard 26 was previously detached from a base plate 28 of skateboard 26 by unscrewing an axle bolt 29 from a threaded bolt receiving hole 30 in base plate 28. Truck insert 10 has been attached to base plate 28 by positioning truck insert pin 12 in a pin receiving hole 31 in base plate 28, and screwing truck insert bolt 22 in bolt receiving hole 30 in base plate 28. Axle 27 has been attached to truck insert 10 by positioning an axle pin 32 in pin receiving hole 23 on truck insert 10, and screwing axle bolt 29 in bolt receiving hole 24 in truck insert 10.

Bushings 33 and 34 are positioned on the top and bottom of a mounting portion 35 of axle 27. Cupped washers 36 and 37 are positioned against the outer sides of bushings 33 and 34. Wheels 38 and 39 are attached to opposite ends of axle 27. Base plate 28 is attached to the bottom of a board 40. Another set of truck and truck insert (not shown) is attached to the other end of board 40 as a mirror image of the set shown.

Truck insert 10 and axle 27 are shown in a neutral position in the side view in FIG. 2 and the bottom view in FIG. 3. Bolts 22 and 29 may be tightened to reduce board roll resistance, and loosened to increase board roll resistance. Bolts 22 and 29 are preferably adjusted to provide a suitable amount of roll resistance to prevent wobbling, and therefore provide a level of directional stability comparable to before truck insert 10 is added.

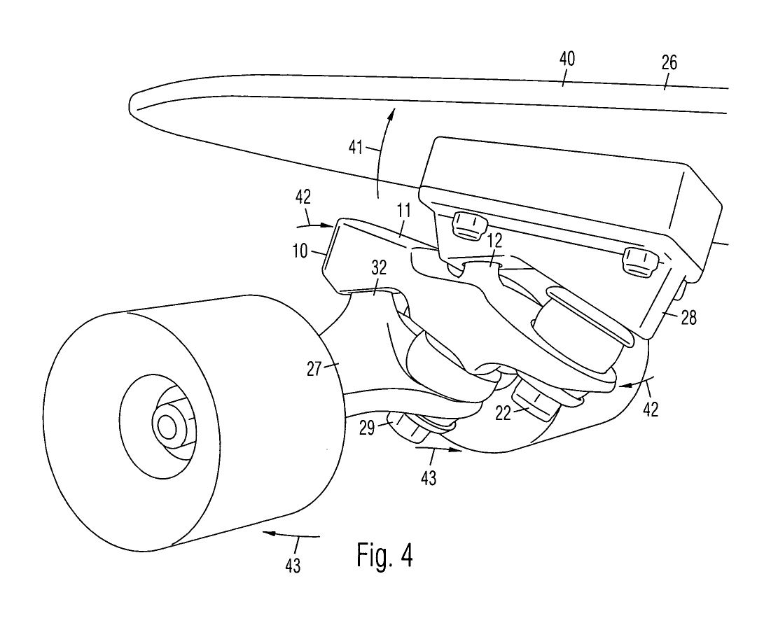

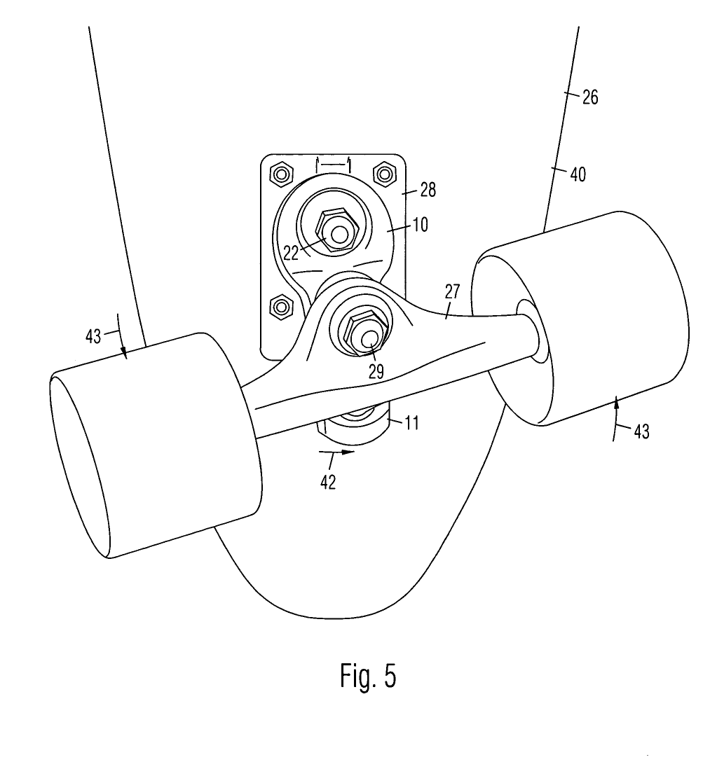

FIGS. 4-5

Truck insert 10 and axle 27 are shown in a rotated condition in the side view in FIG. 4 and the bottom view in FIG. 5. In the example shown, board 40 of skateboard 26 is rolled to the right at about its longitudinal axis by foot pressure, as indicated by arrow 41. Truck insert 10 is rotated about truck insert pin 12 as indicated by arrow 42, and axle 27 is rotated about axle pin 32 in the same direction, as indicated by the arrows 43. The combined rotation of truck insert 10 and axle 27 significantly increases axle steering relative to the axle steering possible before truck insert 10 is installed. Therefore, turning radius is significantly reduced for better maneuverability without sacrificing directional stability.

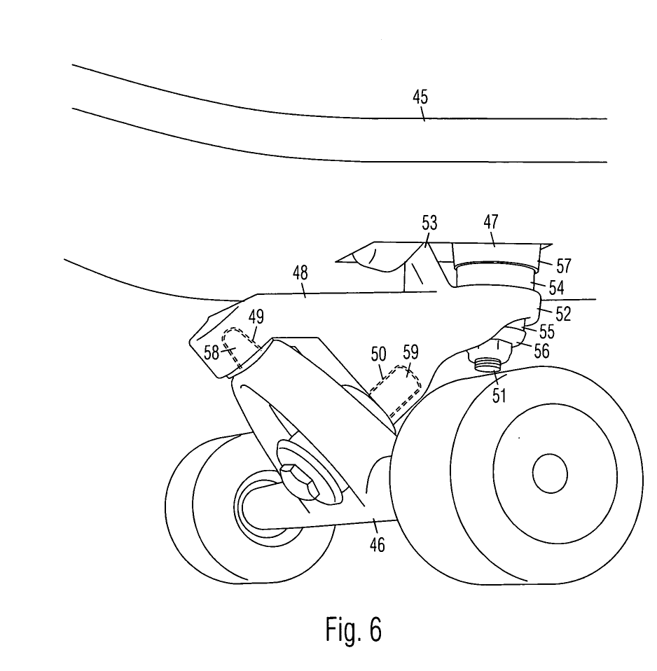

FIG. 6

An alternative truck insert 44 shown in FIG. 6 is attached to a different type of skateboard 45 with an axle 46 and a base plate 47. Axle 46 has been detached from base plate 47 and truck insert 44 has been positioned there between. Truck insert 44 is comprised of an intermediary member 48 with a pin receiving hole 49 and a bolt receiving hole 50 on a bottom side at approximately 90 degrees to each other. Truck insert 44 is further comprised of a truck insert bolt 51 positioned through a mounting portion 52 and a truck insert pin 53. Bushings 54 and 55 are positioned around bolt 51 on either side of mounting portion, and cupped washers 56 and 57 are positioned on the outside ends of respective bushings 54 and 55. Truck insert bolt 51 is secured in base plate 47, and truck insert pin 53 is positioned in base plate 47. An axle pin 58 on axle 46 is positioned inside pin receiving hole 49 in truck insert 44, and an axle bolt 59 is positioned inside bolt receiving hole 50 in truck insert 44.

Although the foregoing description is specific, it should not be considered as a limitation on the scope of the invention, but only as an example of the preferred embodiment. Many variations are possible within the teachings of the invention. For example, truck insert 10 maybe provided as part of a complete truck assembly which includes base plate 28, truck insert 10, and axle 27, or as part of a complete skateboard. Therefore, the scope of the invention should be determined by the appended claims and their legal equivalents, not by the examples given.

1. A skateboard truck insert for being positioned between a base plate and an axle of a skateboard truck, comprising:
an intermediary member;
a truck insert pin projecting from said intermediary member for positioning in a pin receiving hole in said base plate;
a mounting portion on said intermediary member with a through hole; and
an axle pin receiving hole on said intermediary member for receiving an axle pin projecting from said axle; and
an axle bolt receiving hole for receiving an axle bolt extending from said axle.

2. The skateboard truck insert of claim 1, further including:
a first bushing and a second bushing on either side of said mounting portion coaxial with said through hole;
a truck insert bolt positioned through said second bushing, said through hole, and first second bushing for positioning in said bolt receiving hole in said base plate.

3. The skateboard truck insert of claim 2, wherein said truck insert pin and truck insert bolt are longitudinally offset from said axle pin receiving hole and said axle bolt receiving hole.

4. The skateboard truck insert of claim 1, further including:
a first recess and a second recess on either side of said mounting portion coaxial with said through hole;
a first bushing and a second bushing respectively positioned in said first recess and said second recess;
a first washer and a second washer positioned against respective outer ends of said first bushing and said second bushing; and
a truck insert bolt positioned through said second washer, said second bushing, said through hole, said first bushing, and said first washer for positioning in said bolt receiving hole on said base plate.

5. The skateboard truck insert of claim 4, wherein said truck insert pin and truck insert bolt are longitudinally offset from said axle pin receiving hole and said axle bolt receiving hole.

6. A skateboard truck assembly, comprising:
a base plate for attaching to a board of a skateboard, said base plate including:
a pin receiving hole; and
a bolt receiving hole;
an intermediary member below said base plate, said intermediary member including;
a truck insert pin projecting into said pin receiving hole in said base plate;
a mounting portion with a through hole;
an axle pin receiving hole; and
an axle bolt receiving hole;
a first bushing and a second bushing positioned on either side of said mounting portion coaxial with said through hole;
a truck insert bolt positioned through said second bushing, said through hole, and said first bushing and secured in said bolt receiving hole on said base plate;
an axle below said intermediary member for attaching a pair of wheels, said axle including:
an axle pin projecting into said axle pin receiving hole in said intermediary member; and
an axle bolt extending from said axle into said axle bolt receiving hole in said intermediary member.

7. The skateboard truck assembly of claim 6, wherein said truck insert pin and truck insert bolt are longitudinally offset from said axle pin receiving hole and said axle bolt receiving hole.

8. The skateboard truck assembly of claim 6, further including:
a first recess and a second recess on either side of said mounting portion coaxial with said through hole, wherein said first bushing and said second bushing are respectively positioned in said first recess and said second recess; and
a first washer and a second washer positioned against respective outer ends of said first bushing and said second bushing.
